(19) United States
(12) Patent Application Publication
(10) Pub. No.: US 2012/0099298 A1
(43) Pub. Date: Apr. 26, 2012

(54) LIGHT-EMITTING CLOTHING STRUCTURE

(75) Inventor: Yen-Chou Hsu, Tao-Yuan City (TW)

(73) Assignee: LEDSTORE INTERNATIONAL CORPORATION, Tao-Yuan City (TW)

(21) Appl. No.: 12/908,693

(22) Filed: Oct. 20, 2010

(51) Int. Cl. F21V 21/08

(52) U.S. Cl. 362/103

(57) ABSTRACT

A light-emitting clothing structure includes a clothing body, a light emitting unit movably coupled to the clothing body, and a connecting unit disposed between the clothing body and the light emitting unit. The connecting unit is configured to mount the light emitting unit on the clothing body. The light emitting unit emits light to achieve an anticipated aesthetic appearance and alert effect, when the light-emitting clothing structure is worn by a user.

### FIELD OF THE INVENTION

The present invention relates to light-emitting clothing structures, in particular to a light-emitting clothing structure having a clothing body, a light emitting unit coupled to the clothing body through a connecting unit for emitting light required to achieve an anticipated aesthetic appearance and alert effect of the light-emitting clothing structure thus proposed.

### BACKGROUND OF THE INVENTION

In general, clothing is provided for human beings to wear and cover the human bodies.

However, a conventional clothing body does not have any additional function other than covering the human body. When a user wears the conventional clothing body while walking or riding a bicycle in the nighttime, the conventional clothing body does not emit the light required for achieving the anticipated aesthetic appearance and alert effect of the light-emitting clothing structure thus proposed. Obviously, the conventional clothing body does not meet the requirements of a practical use.

Therefore, it is imperative for related manufacturers and designers to create a light-emitting clothing structure for achieving the anticipated aesthetic appearance and alert effect of the light-emitting clothing structure thus proposed.

### SUMMARY OF THE INVENTION

In view of the shortcomings of the conventional clothing structure, the inventor of the present invention conducted extensive researches and experiments according to the inventor's years of experience in the related industry, and finally developed a light-emitting clothing structure as disclosed in the present invention to achieve the anticipated aesthetic appearance and alert effect of the light-emitting clothing structure thus proposed.

It is a primary objective of the present invention to provide a light-emitting clothing structure, wherein a connecting unit is provided for installing a light emitting unit on the clothing body, such that the clothing body worn by a wearer can emit light from the light emitting unit to achieve the anticipated aesthetic appearance and alert effect of the light-emitting clothing structure thus proposed.

To achieve the foregoing and other objectives, the present invention discloses a light-emitting clothing structure comprising a clothing body, a light emitting unit movably coupled to the clothing body, and a connecting unit disposed between the clothing body and the light emitting unit.

In a preferred embodiment of the present invention, the clothing body can be a garment or a trouser, and the clothing body includes a covering portion for covering the light emitting unit, and a pocket positioned on the clothing body.

In a preferred embodiment of the present invention, the covering portion is transparent.

In a preferred embodiment of the present invention, the light emitting unit includes a light emitting strip, a power supply portion, and an ON/OFF switch portion electrically connected with each other, and a plurality of fixing holes positioned on two sides of the light emitting strip respectively and coupled to a side of the connecting unit.

In a preferred embodiment of the present invention, the light emitting strip comprises a plurality of light emitting diodes connected in series or a plurality of light bulbs connected in series.

In a preferred embodiment of the present invention, the power supply portion can be a fuel cell or a battery.

In a preferred embodiment of the present invention, the ON/OFF switch portion is a stepwise press-button switch, a photosensitive switch, or a sensor.

In a preferred embodiment of the present invention, the connecting unit is a Velcro tape with a hook-side portion and a loop-side portion whereby the light emitting unit is movably coupled to the clothing body.

In a preferred embodiment of the present invention, the hook-side portion is disposed on the clothing body, and the loop-side portion is coupled to the light emitting unit.

In a preferred embodiment of the present invention, the loop-side portion is disposed on the clothing body, and the hook-side portion is coupled to the light emitting unit.

In the light-emitting clothing structure of the present invention, the connecting unit is provided for mounting the light emitting unit on the clothing body, such that the clothing body worn on a wearer's body can emit light from the light emitting unit to achieve the anticipated aesthetic appearance and alert effect of the light-emitting clothing structure thus proposed.

### BRIEF DESCRIPTION OF THE DRAWINGS

FIG. 1 is a perspective view of a preferred embodiment of the present invention; and

FIG. 2 is an exploded view of a preferred embodiment of the present invention.

### DETAILED DESCRIPTION OF THE PREFERRED EMBODIMENTS

The objects, characteristics and effects of the present invention will become apparent with the detailed description of the preferred embodiments and the illustration of related drawings as follows.

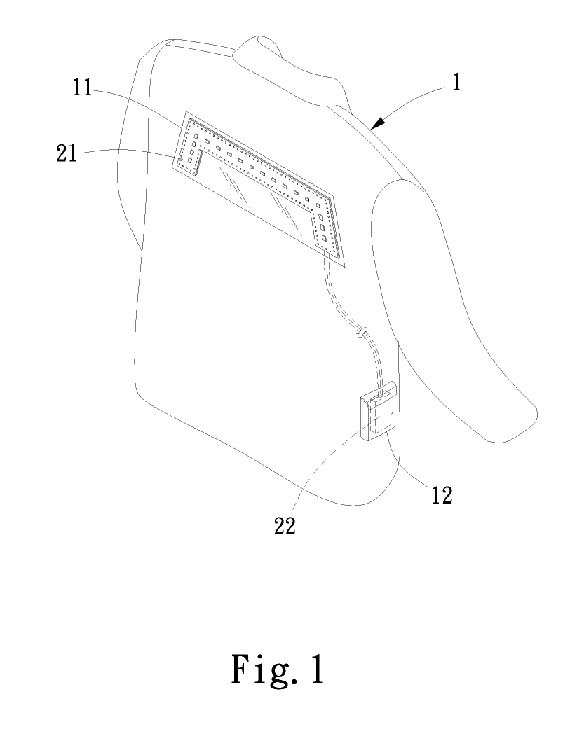

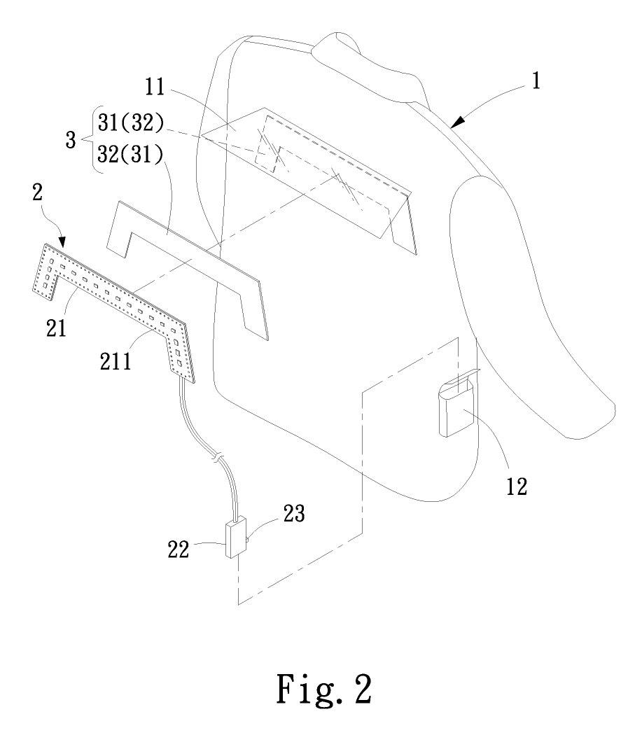

With reference to FIGS. 1 and 2 for a light-emitting clothing structure of the present invention, the light-emitting clothing structure comprises a clothing body 1, a light emitting unit 2, and a connecting unit 3.

The clothing body 1 can be a garment or a trouser. The clothing body 1 includes a transparent covering portion 11 and a pocket 12.

The light emitting unit 2 is movably coupled to the clothing body 1, and covered by the covering portion 11. The light emitting unit 2 includes a light emitting strip 21, a power supply portion 22, and an ON/OFF switch portion 23 electrically connected with each other. The light emitting strip 21 comprises a plurality of light emitting diodes connected in series or a plurality of light bulbs connected in series. The power supply portion 22 is a fuel cell or a battery disposed in the pocket 12. The ON/OFF switch portion 23 is a stepwise press-button switch, a photosensitive switch, or a sensor. A plurality of fixing holes 211 are positioned on two sides of the light emitting strip 21 respectively.

The connecting unit 3 is disposed between the clothing body 1 and the light emitting unit 2. The connecting unit 3 is a Velcro tape with a hook-side portion 31 and a loop-side portion 32 whereby the light emitting unit 2 is movably coupled to the clothing body 1. In an embodiment of the present invention, the hook-side portion 31 is disposed on the clothing body 1, and the loop-side portion 32 is coupled to the light emitting strip 21 of the light emitting unit 2, with the light emitting strip 21 being coupled to the loop-side portion 32 by means of the fixing holes 211 positioned on the two sides of the light emitting strip 21. In another embodiment of the present invention, the loop-side portion 32 is disposed on the clothing body 1, and the hook-side portion 31 is coupled to the light emitting strip 21 of the light emitting unit 2, with the light emitting strip 21 being coupled to the hook-side portion 31 by means of the fixing holes 211 positioned on the two sides of the light emitting strip 21.

In a further embodiment of the present invention, the hook-side portion 31 (or the loop-side portion 32) of the connecting unit 3 assumes a desired shape or pattern by sewing. Then, the loop-side portion 32 (or the hook-side portion 31) of the connecting unit 3 assumes a shape or pattern corresponding to that of the hook-side portion 31 (or the loop-side portion 32) by sewing. The light emitting strip 21 assumes the aforesaid predetermined shape or pattern, after the light emitting strip 21 has been coupled to the loop-side portion 32 (or the hook-side portion 31) by means of the fixing holes 211. A user who wears the clothing body 1 while walking or riding a bicycle in the nighttime can turn on the ON/OFF switch portion 23 of the light emitting unit 2, such that the power supply portion 22 supplies the required electric power to the light emitting strip 21. As a result, and the light emitting strip 21 emits a direct-projecting light ray or a flashing light ray according to the stepwise configuration of use of the ON/OFF switch portion 23, so as to achieve the anticipated illumination and alert effects of the light-emitting clothing structure thus proposed. The clothing body 1 achieves the anticipated aesthetic appearance and alert effect of the light-emitting clothing structure thus proposed when worn by the user.

Before washing the clothing body 1, the user has to take the power supply portion 22 out of the pocket 12, and then remove the light emitting strip 21 from the clothing body 1 by separating the hook-side portion 31 and the loop-side portion 32. In so doing, the light emitting unit 2 is prevented from being damaged by water during the washing process of the clothing body 1.

In conclusion, the present invention discloses the connecting unit for mounting the light emitting unit on the clothing body, such that the clothing body of the light-emitting clothing structure emits light from the light emitting unit to achieve an anticipated aesthetic appearance and alert effect when worn by a user. In addition, products of the invention can meet the market requirements, and the present invention complies with patent application requirements, and thus a patent application is hereby duly filed to claim patent protection for the present invention.

While the invention has been described by means of specific embodiments, numerous modifications and variations could be made thereto by those skilled in the art without departing from the scope and spirit of the invention set forth in the claims.

What is claimed is:

1. A light-emitting clothing structure, comprising:
a clothing body;
a light emitting unit movably coupled to the clothing body; and
a connecting unit disposed between the clothing body and the light emitting unit.

2. The light-emitting clothing structure of claim 1, wherein the clothing body is a garment or a trouser and has a covering portion and a pocket, the covering portion covering the light emitting unit, and the pocket being positioned on the clothing body.

3. The light-emitting clothing structure of claim 2, wherein the covering portion is transparent.

4. The light-emitting clothing structure of claim 1, wherein the light emitting unit includes a light emitting strip, a power supply portion, and an ON/OFF switch portion electrically connected with one another, and the light emitting strip includes a plurality of fixing holes positioned on two sides of the light emitting strip respectively and coupled to a side of the connecting unit.

5. The light-emitting clothing structure of claim 4, wherein the light emitting strip comprises a plurality of light emitting diodes connected in series or a plurality of light bulbs connected in series.

6. The light-emitting clothing structure of claim 4, wherein the power supply portion is a fuel cell or a battery.

7. The light-emitting clothing structure of claim 4, wherein the ON/OFF switch portion is one of a stepwise press-button switch, a photosensitive switch, and a sensor.

8. The light-emitting clothing structure of claim 1, wherein the connecting unit is a Velcro tape with a hook-side portion and a loop-side portion whereby the light emitting unit is movably coupled to the clothing body.

9. The light-emitting clothing structure of claim 1, wherein the hook-side portion is disposed on the clothing body, and the loop-side portion is coupled to the light emitting unit.

10. The light-emitting clothing structure of claim 1, wherein the loop-side portion is disposed on the clothing body, and the hook-side portion is coupled to the light emitting unit.
